(19) United States
(12) Patent Application Publication
(10) Pub. No.: US 2026/0211258 A1
(43) Pub. Date: Jul. 23, 2026

(54) OPTICAL ELEMENT DRIVING MECHANISM

(71) Applicant: Actutek Corporation, Taoyuan City (TW)

(72) Inventors: Ya-Hsiu WU, Taoyuan City (TW); Yi-Ho CHEN, Taoyuan City (TW); Ying-Jen WANG, Taoyuan City (TW)

(21) Appl. No.: 19/456,565

(22) Filed: Jan. 22, 2026

Related U.S. Application Data
(60) Provisional application No. 63/748,691, filed on Jan. 23, 2025.

(51) Int. Cl. G02B 27/64

(52) U.S. Cl. CPC G02B 27/64

(57) ABSTRACT

An optical element driving mechanism is provided. The optical element driving mechanism includes a first movable part, a fixed part, and a first driving assembly. The first movable part is configured to connect to an optical element. The first movable part is movable relative to the fixed part. The first driving assembly is for driving the first movable part to move.

### CROSS REFERENCE TO RELATED APPLICATIONS

This application claims the benefit of U.S. provisional application No. 63/748,691, filed Jan. 23, 2025, the entirety of which is incorporated by reference herein.

### TECHNICAL FIELD

The present invention relates to an optical element driving mechanism, and, in particular, it relates to an optical element driving mechanism having multiple driving assemblies, multiple movable parts, and multiple supporting assemblies, wherein the multiple movable parts drive an optical element to move.

### BACKGROUND

There has been significant the development in the design and manufacture of mobile devices, portable imaging equipment, and high-precision optical systems. As a result, there has been a continued increase in the requirements on optical modules with regards to positioning accuracy, stability, and the response speed of optical elements. In order to achieve optical image stabilization and auto-focusing, it is often necessary to provide an optical element driving mechanism so that the optical element can perform precise and controllable movements relative to a fixed part.

However, if the supporting structure in the prior art is not properly arranged, interference, uneven friction, or insufficient stability may easily occur when the movable part moves. In addition, if magnetic driving elements and magnetic stabilizing elements are not properly arranged, magnetic interference, sensing errors, and difficulties in reducing structural dimensions may result. Furthermore, in multi-movable part structures, electrical connections and supporting arrangements often fail to simultaneously achieve reliability and modularity due to spatial limitations.

Existing optical modules often utilize multi-layer supporting structures or multi-layer ball-rail structures to enhance rigidity of support and stability of motion. However, multi-layer ball-rail supports often require more stacked space in the height direction, making it detrimental for miniaturization and any effort to reduce thickness. On the other hand, if only a single-layer structure is adopted to reduce stacking, rotational motion may occur simultaneously during translational motion, making control difficult and affecting imaging quality.

Accordingly, there is a need for a driving mechanism architecture that can maintain stability of motion within a limited space, effectively suppress rotation, and improve reliability, while also offering high structural configuration flexibility, excellent stability, and favorable sensing and driving integration, so as to overcome the aforementioned deficiencies.

### BRIEF SUMMARY

The terms “embodiment” and similar expressions (e.g., implementation, arrangement, feature, example, and option) are intended to broadly refer to all subject matter of the present invention and the following claims. Statements containing these terms are to be understood as not limiting the subject matter described herein nor limiting the meaning or scope of the following claims. The embodiments encompassed by the present invention are defined by the claims, not by the summary. This summary provides a high-level overview of various features of the invention and introduces certain concepts that are described in greater detail in the following embodiment sections. This description of the invention is not intended to identify key or essential features of the claimed subject matter, nor is it intended to be used independently to determine the scope of the claimed subject matter. The subject matter should be understood with reference to the appropriate portions of the full specification of the invention, any or all accompanying drawings, and each of the claims.

According to certain aspects of the present disclosure, an optical element driving mechanism is provided. The optical element driving mechanism includes a first movable part, a fixed part, and a first driving assembly. The first movable part is configured to connect an optical element. The first movable part is movable relative to the fixed part. The first driving assembly is configured to drive the first movable part to move.

According to certain aspects of the present disclosure, the optical element driving mechanism further includes a first supporting assembly and a second supporting assembly. The first movable part is movable relative to the fixed part via the first supporting assembly. The first movable part is movable relative to the fixed part via the second supporting assembly. A first supporting element of the first supporting assembly has a plate-shaped structure. A second supporting element of the second supporting assembly has a curved surface, and the curved surface is not parallel to a thickness direction of the first supporting element.

The foregoing summary is not intended to present every embodiment or every feature of the present disclosure. Instead, the above summary merely provides examples of some of the novel features and characteristics described herein. When taken together with the drawings and the appended claims, the following detailed description of representative embodiments and modes for carrying out the invention will make the above-mentioned features and advantages, as well as other features and advantages of the present disclosure, apparent. In view of the drawings provided below for the detailed description of various embodiments, additional features of the present disclosure will be apparent to those of ordinary skill in the art.

### BRIEF DESCRIPTION OF THE DRAWINGS

The present disclosure can be more fully understood by reading the subsequent detailed description and examples with references made to the accompanying drawings. These drawings illustrate only exemplary embodiments and thus should not be regarded as limiting the various embodiments or the scope of the claims.

FIG. 1A is a perspective view of an optical element driving mechanism according to certain aspects of the present disclosure.

FIG. 1B is a perspective view of the optical element driving mechanism according to certain aspects of the present disclosure, wherein a housing is removed for illustrative purposes.

FIG. 2 is an exploded perspective view of the optical element driving mechanism according to certain aspects of the present disclosure.

FIG. 3 is a perspective view of a second movable part of the optical element driving mechanism according to certain aspects of the present disclosure.

FIG. 4 is a perspective view of a lower cover of the optical element driving mechanism according to certain aspects of the present disclosure.

FIG. 5 is a perspective view of a first driving assembly of the optical element driving mechanism according to certain aspects of the present disclosure.

FIG. 6 is a perspective view of a first driving assembly and a second driving assembly of the optical element driving mechanism according to certain aspects of the present disclosure.

FIG. 7 is a perspective view of a first supporting assembly of the optical element driving mechanism according to certain aspects of the present disclosure.

FIG. 8 is a partially enlarged perspective view illustrating the first supporting assembly assembled with a first movable part, a second movable part, and a fixed part according to certain aspects of the present disclosure.

FIG. 9 is a perspective view of a second supporting assembly of the optical element driving mechanism according to certain aspects of the present disclosure.

FIG. 10 is a partially enlarged perspective view of the second supporting assembly according to certain aspects of the present disclosure.

FIG. 11 is a sectional view of the optical element driving mechanism taken along line A-A of FIG. 1A according to certain aspects of the present disclosure.

FIG. 12 is a perspective view illustrating the lower cover assembled with a stabilizing assembly and a sensing assembly of the optical element driving mechanism according to certain aspects of the present disclosure.

### DETAILED DESCRIPTION

Multiple embodiments are described with reference to the drawings, in which like reference numerals are used throughout to designate similar or equivalent elements. The drawings are not drawn to scale, and are provided merely to illustrate the features and characteristics of the present disclosure. It should be understood that numerous specific details, relationships, and methods are described to provide a thorough understanding. However, one of ordinary skill in the art will readily appreciate that multiple embodiments may be practiced without one or more of the specific details, or using other methods. In some instances, well-known structures or operations are not shown in detail for purposes of illustration. The various embodiments are not limited to the illustrated sequence of actions or events, as some actions may occur in different sequences and/or concurrently with other actions or events. Furthermore, not all illustrated actions or events are required for practicing certain aspects and features of the present disclosure.

For purposes of the present embodiment, unless explicitly stated otherwise, the singular includes the plural and vice versa. The term “including” means “including but not limited to.” In addition, approximate terms such as “about,” “almost,” “substantially,” or “approximately,” and similar expressions may be understood herein to mean, for example, “at,” “near,” “nearly at,” “within 3-5% of,” “within acceptable manufacturing tolerances,” or any logical combination thereof. Additionally, the terms “vertical” or “horizontal” are intended to further include directions within “3-5% of” vertical or horizontal, respectively. Furthermore, directional terms such as “top,” “bottom,” “left,” “right,” “upper,” and “lower” are intended to refer to equivalent directions as depicted in the referenced illustrations; as understood from the context of the referenced object or component, such as its customary orientation; or other similar descriptions.

It will be understood that although the terms “first,” “second,” and the like may be used herein to describe various elements, layers, and/or portions, such elements, layers, and/or portions should not be limited by these terms, which are used merely to distinguish one element, layer, or portion from another. Thus, a first element, layer, and/or portion discussed below may be referred to as a second element, layer, and/or portion without departing from the teachings of certain embodiments of the present disclosure. Additionally, for brevity, the terms “first,” “second,” and the like may be omitted in the specification when distinguishing between different elements. Without departing from the scope defined by the appended claims, the first element and/or second element recited in the claims may be interpreted as any element that fits the description in the specification.

It should be noted that the technical solutions provided by different embodiments below may be interchanged, combined, or used in mixed form to constitute another embodiment, so long as doing so does not depart from the spirit of the present disclosure.

The present disclosure relates to an optical element driving mechanism having multiple driving assemblies, multiple movable parts, and multiple supporting assemblies, in which the multiple movable parts drive an optical element to move flexibly in various directions, thereby adjusting the imaging of the optical element driving mechanism to accommodate different imaging requirements.

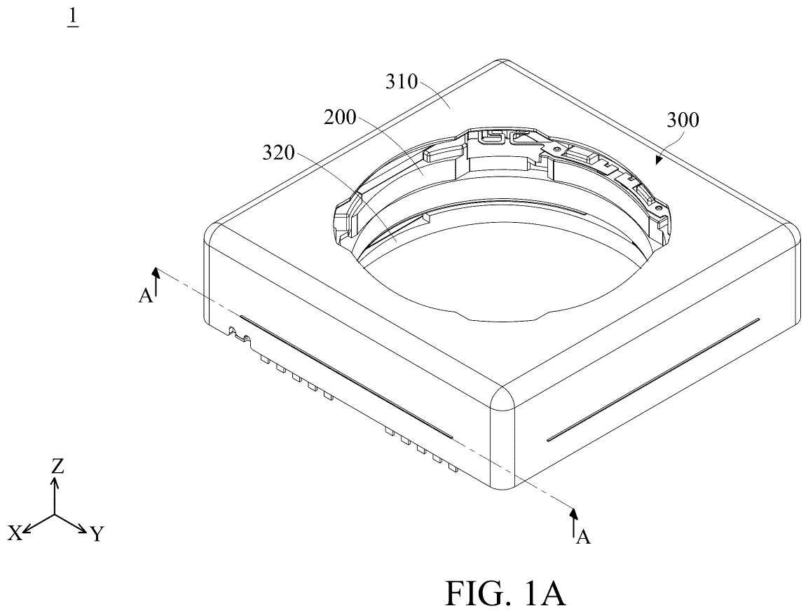

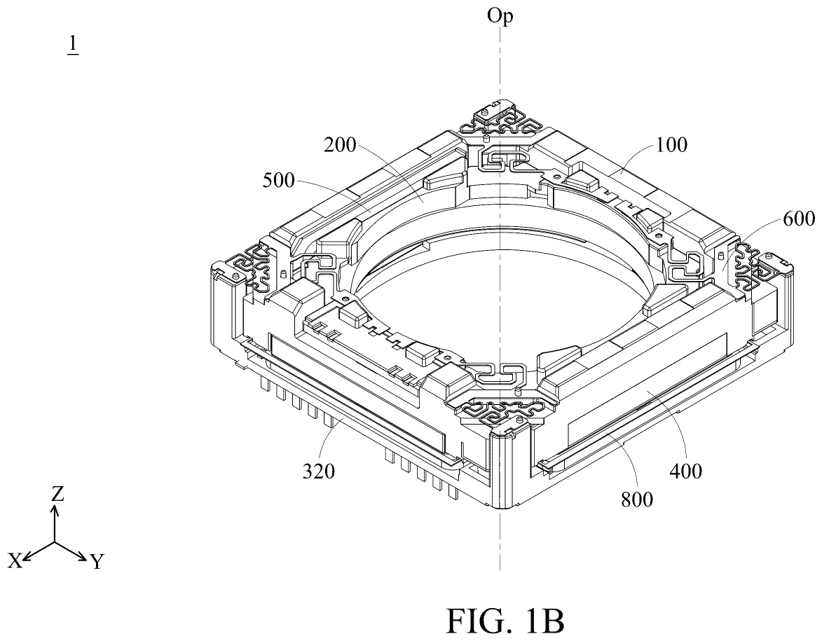

First, please refer to FIGS. 1A and 1B together. FIG. 1A is a perspective view of an optical element driving mechanism 1 according to certain aspects of the present disclosure. FIG. 1B is a perspective view of the optical element driving mechanism 1 according to certain aspects of the present disclosure, wherein a housing 310 is removed for illustrative purposes.

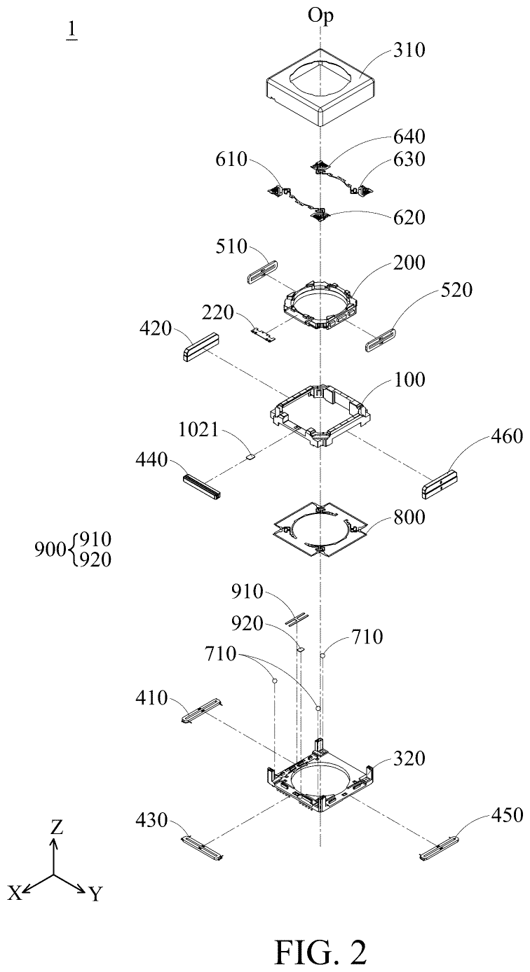

Next, please refer to FIG. 2. FIG. 2 is an exploded perspective view of the optical element driving mechanism 1 according to certain aspects of the present disclosure.

The optical element driving mechanism 1 includes a first movable part 100, a second movable part 200, a fixed part 300, a first driving assembly 400, a second driving assembly 500, a first supporting assembly 600, a second supporting assembly 700, a third supporting assembly 800, a stabilizing assembly 900, and a sensing assembly 1000.

Incident light from an external source may pass through the optical element driving mechanism 1 along an optical axis Op. The first movable part 100 and the second movable part 200 are configured to connect an optical element. The first movable part 100 and the second movable part 200 are movable relative to the fixed part 300. The first driving assembly 400 is configured to drive the first movable part 100 to move. The second movable part 200 is movable relative to the first movable part 100. The second driving assembly 500 is configured to drive the second movable part 200 to move. The first movable part 100 and the second movable part 200 are movable relative to the fixed part 300 via the first supporting assembly 600. The first movable part 100 is movable relative to the fixed part 300 via the second supporting assembly 700. The second movable part 200 is movably connected to the first movable part 100 via the third supporting assembly 800. The stabilizing assembly 900 is configured to stabilize the first movable part 100. The sensing assembly 1000 is configured to sense movements of the first movable part 100 and the second movable part 200.

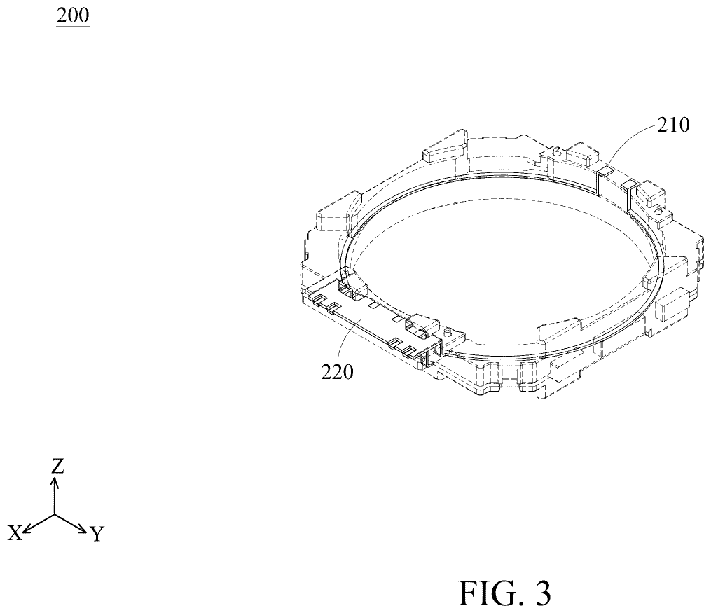

Next, please refer to FIG. 3. FIG. 3 is a perspective view of the second movable part 200 of the optical element driving mechanism 1 according to certain aspects of the present disclosure.

The second movable part 200 may directly or indirectly connect the optical element and the first movable part 100. The second movable part 200 includes a circuit member 210 and an electronic component 220. The circuit member 210 is at least partially embedded in the second movable part 200. The circuit member 210 is connected to the electronic component 220 and the first supporting assembly 600.

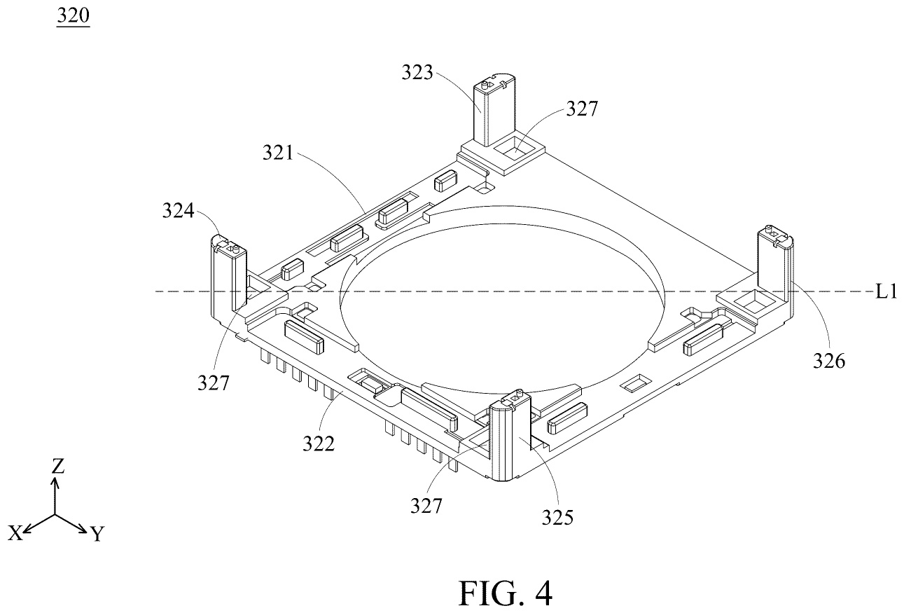

Next, please refer to FIGS. 2 and 4 together. FIG. 4 is a perspective view of a lower cover 320 of the optical element driving mechanism 1 according to certain aspects of the present disclosure.

The fixed part 300 has a polygonal structure and includes a housing 310 and a lower cover 320. The lower cover 320 includes a first side 321, a second side 322, a first corner 323, a second corner 324, a third corner 325, and a fourth corner 326. The first corner 323 is adjacent to the first side 321. The second corner 324 is located between the first side 321 and the second side 322. The third corner 325 is adjacent to the second side 322. When viewed along the optical axis Op, a diagonal line L1 passes through the second corner 324 and the fourth corner 326.

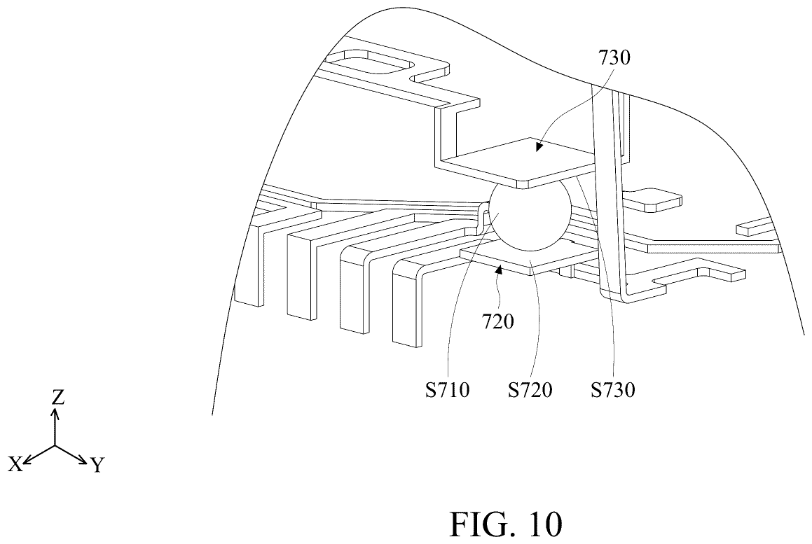

The first corner 323, the second corner 324, the third corner 325, and the fourth corner 326 of the lower cover 320 respectively include a plurality of receiving recesses 327. Each receiving recess 327 is configured to receive a portion of the second supporting assembly 700, so that the first movable part 100 is movably connected to the fixed part 300 via the second supporting assembly 700, as will be further described in detail below with reference to FIG. 10 and the second supporting assembly 700.

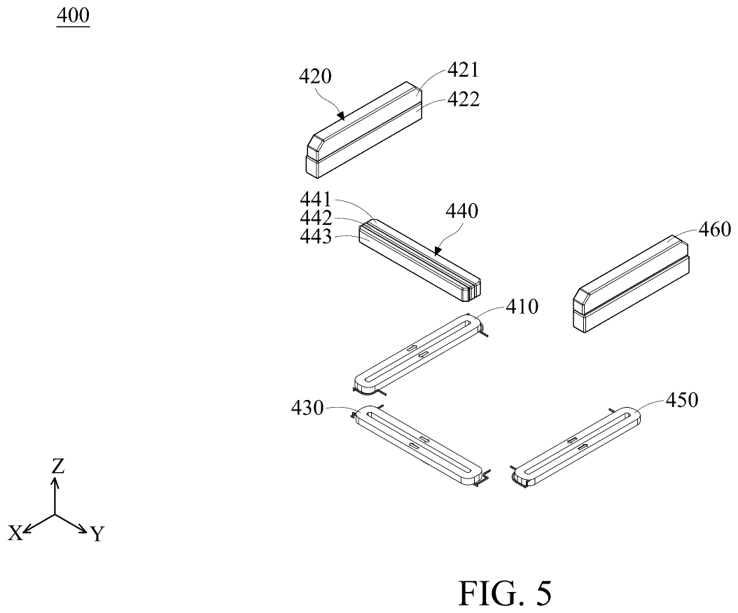

Next, please refer to FIGS. 2, 4, and 5 together. FIG. 5 is a perspective view of a first driving assembly 400 of the optical element driving mechanism 1 according to certain aspects of the present disclosure.

The first driving assembly 400 and the second driving assembly 500 may be driving assemblies such as a magnet and a coil, a piezoelectric element, a stepping motor, or a shape memory alloy, for example. In the present embodiment, the first driving assembly 400 is a driving assembly in the form of magnets and coils, and includes a first coil 410, a first magnet 420, a second coil 430, a second magnet 440, a third coil 450, and a third magnet 460. The first magnet 420 corresponds to the first coil 410. The second magnet 440 corresponds to the second coil 430. The third magnet 460 corresponds to the third coil 450.

The magnet of the driving assembly may be composed of multiple small magnets or may be integrally formed. In the present embodiment, the first magnet 420 includes two small magnets 421 and 422, which are fixed with opposite magnetic pole distributions. The second magnet 440 includes three small magnets 441, 442, and 443. The third magnet 460 also includes two small magnets and is likewise fixed with opposite magnetic pole distributions.

The first coil 410, the second coil 430, and the third coil 450 are disposed on the lower cover 320. When viewed along the optical axis Op, the first coil 410 is located on the first side 321, and the second coil 430 is located on the second side 322. The winding of the first coil 410 has a different number of turns than the number of turns of the second coil 430. In the present embodiment, the number of turns of the second coil 430 is greater than that of the first coil 410. The first magnet 420, the second magnet 440, and the third magnet 460 are disposed on the first movable part 100.

The first coil 410 and the first magnet 420, and the third coil 450 and the third magnet 460 generate an electromagnetic driving force in the Y-axis direction. By means of the electromagnetic driving force generated between the first coil 410 and the first magnet 420, and between the third coil 450 and the third magnet 460 in the Y-axis direction, the first magnet 420 and the third magnet 460 move relative to the first coil 410 and the third coil 450 in the Y-axis direction. Accordingly, the first movable part 100 moves relative to the lower cover 320 in the Y-axis direction.

The second coil 430 and the second magnet 440 generate an electromagnetic driving force in the X-axis direction. By means of the electromagnetic driving force generated between the second coil 430 and the second magnet 440 in the X-axis direction, the second magnet 440 moves relative to the second coil 430 in the X-axis direction. Accordingly, the first movable part 100 moves relative to the lower cover 320 in the X-axis direction.

The multiple driving operations of the first driving assembly 400 allow adjustment of the position of the first movable part 100 and provide sufficient driving force to drive the second movable part 200 and the optical element to achieve optical image stabilization, thereby accommodating various external imaging requirements.

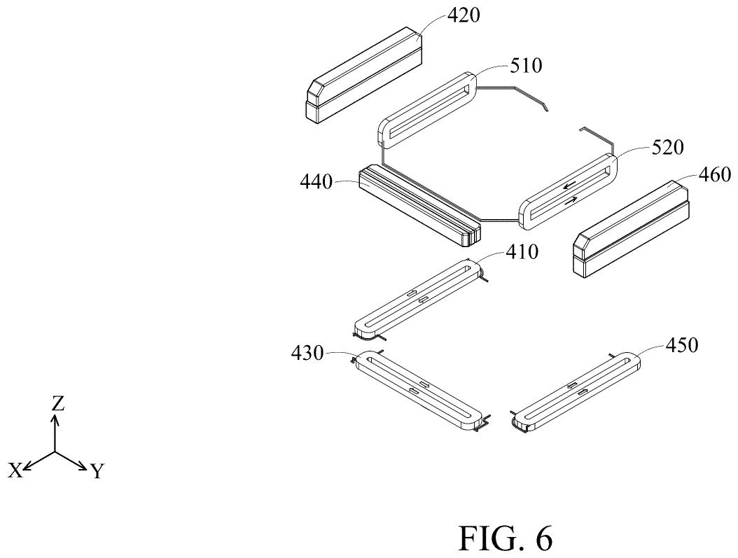

Next, please refer to FIGS. 2 and 6 together. FIG. 6 is a perspective view of the first driving assembly 400 and the second driving assembly 500 of the optical element driving mechanism 1 according to certain aspects of the present disclosure.

The second driving assembly 500 includes a fourth coil 510 and a fifth coil 520. The fourth coil 510 corresponds to the first magnet 420. The fifth coil 520 corresponds to the third magnet 460. In other words, the fourth coil 510 and the first coil 410 correspond to the first magnet 420 together; and the fifth coil 520 and the third coil 450 correspond to the third magnet 460 together. The fourth coil 510 and the fifth coil 520 are disposed on a side of the second movable part 200 opposite the first driving assembly. When viewed along the optical axis Op, the fourth coil 510 is adjacent to the first side 321.

The fourth coil 510 and the first magnet 420, and the fifth coil 520 and the third magnet 460 generate an electromagnetic driving force in the Z-axis direction. By means of the electromagnetic driving force generated between the fourth coil 510 and the first magnet 420, and between the fifth coil 520 and the third magnet 460 in the Z-axis direction, the fourth coil 510 and the fifth coil 520 move relative to the first magnet 420 and the third magnet 460 in the Z-axis direction. Accordingly, the second movable part 200 moves relative to the first movable part 100 in the Z-axis direction.

The multiple driving operations of the second driving assembly 500 allow adjustment of the position of the second movable part 200 and provide sufficient driving force to drive the optical element to adjust an optical imaging focal length, thereby accommodating various external imaging requirements.

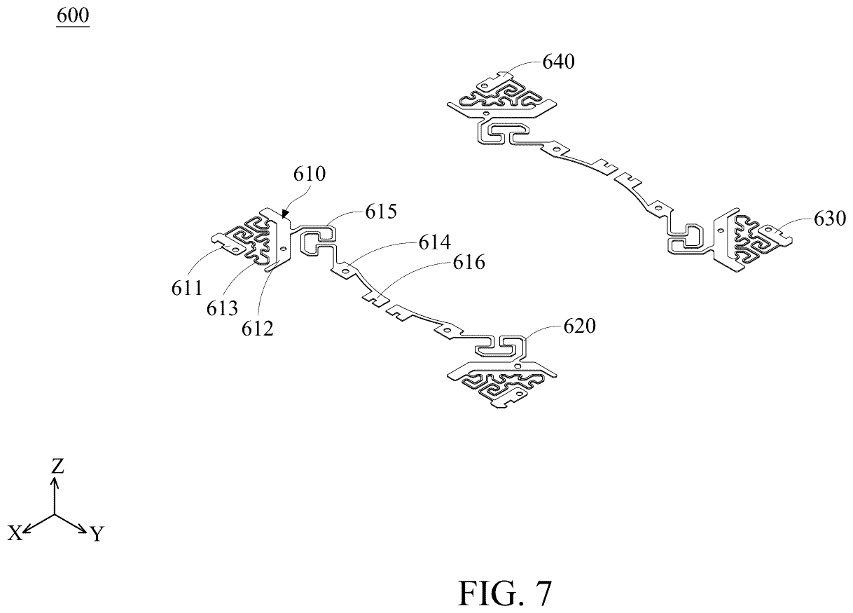

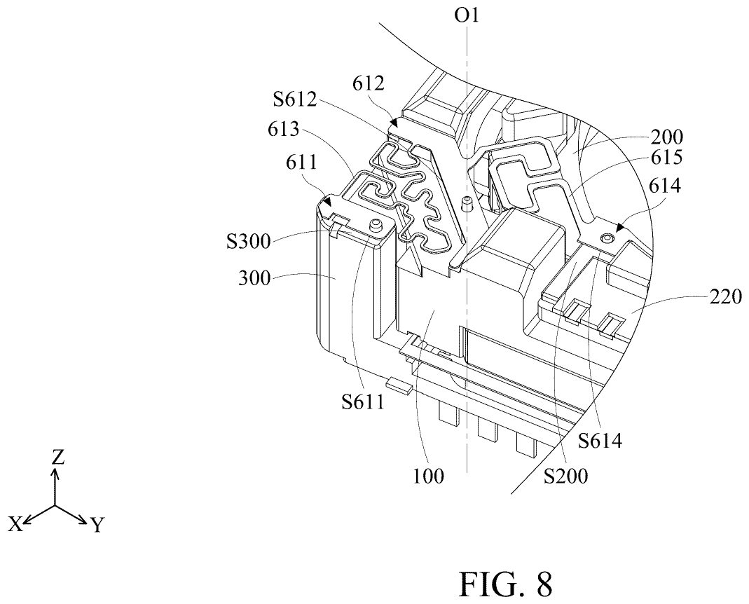

Next, please refer to FIGS. 2, 7, and 8 together. FIG. 7 is a perspective view of a first supporting assembly 600 of the optical element driving mechanism 1 according to certain aspects of the present disclosure. FIG. 8 is a partially enlarged perspective view illustrating the first supporting assembly 600 assembled with the first movable part 100, the second movable part 200, and the fixed part 300 according to certain aspects of the present disclosure.

The first supporting assembly 600 includes a plurality of first supporting elements 610, 620, 630, and 640. These first supporting elements 610, 620, 630, and 640 have similar plate-shaped structures and detailed structures, and in FIG. 7, only one first supporting element 610 is labeled with detailed structure.

The first supporting element 610 includes a fixed part connecting portion 611, a first movable part connecting portion 612, a first elastic portion 613, a second movable part connecting portion 614, a second elastic portion 615, and an electronic component connecting portion 616. The fixed part connecting portion 611 is at least partially fixedly connected to the fixed part 300. The first movable part connecting portion 612 is at least partially fixedly connected to the first movable part 100. The second movable part connecting portion 614 is at least partially fixedly connected to the second movable part 200. The first elastic portion 613 has flexibility. The first movable part connecting portion 612 is connected to the fixed part connecting portion 611 via the first elastic portion 613. The second elastic portion 615 has flexibility. The second movable part connecting portion 614 is connected to the first movable part connecting portion 612 via the second elastic portion 615. The first supporting element 610 is connected to the electronic component 220 via the electronic component connecting portion 616.

The fixed part connecting portion 611 has a fixed part connecting surface S611, and the fixed part connecting surface S611 faces a fixed part surface S300 of the fixed part 300. The first movable part connecting portion 612 has a first movable part connecting surface S612, which faces the fixed part 300. Along a first axis O1, the fixed part connecting surface S611 is located between the fixed part surface S300 and the first movable part connecting surface S612. The first axis O1 is perpendicular to the fixed part connecting surface S611.

The second movable part connecting portion 614 has a second movable part connecting surface S614, which faces a second movable part surface S200 of the second movable part 200. Along the first axis O1, the second movable part connecting surface S614 is located between the second movable part surface S200 and the first movable part connecting surface S612.

The first supporting elements 610, 620, 630, and 640 may be electrically connected to an external optical module, such as an aperture. The optical module and the optical element are arranged along the optical axis Op of the incident light. The first supporting element 610 may be connected to another first supporting element 640 via the circuit member 210, and the first supporting element 620 may be connected to another first supporting element 630 via the circuit member 210. The first supporting element 610 is electrically connected to the electronic component 220 via the electronic component connecting portion 616, and is connected to the second driving assembly 500 via the circuit member 210. The electronic component 220 is also electrically connected to the other first supporting elements 610, 620, 630, and 640 via the circuit member 210.

Along the first axis O1, the electronic component 220 is at least partially located between the first supporting element 610 and the circuit member 210.

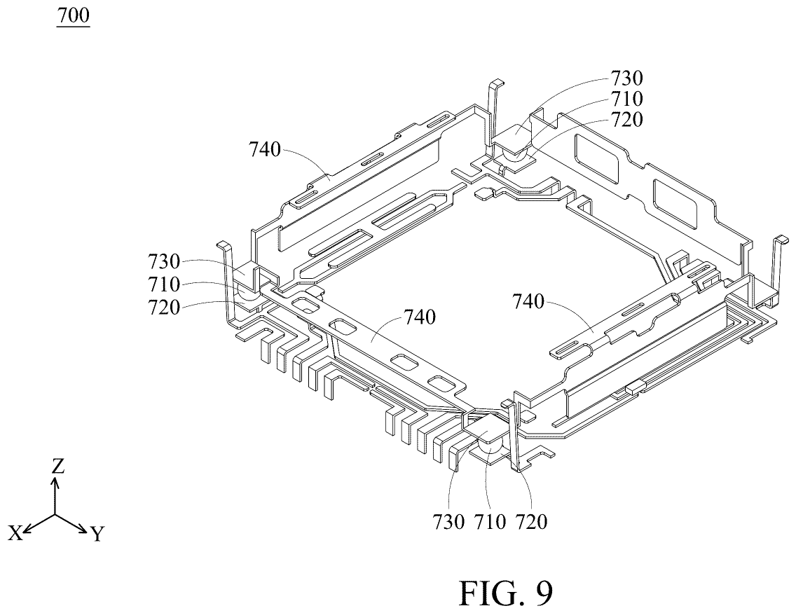

Next, please refer to FIGS. 2, 9, and 10 together. FIG. 9 is a perspective view of a second supporting assembly 700 of the optical element driving mechanism 1 according to certain aspects of the present disclosure. FIG. 10 is a partially enlarged perspective view of the second supporting assembly 700 according to certain aspects of the present disclosure.

The second supporting assembly 700 is disposed between the first movable part 100 and the fixed part 300, and the first movable part 100 is movable relative to the fixed part 300 via the second supporting assembly 700.

The second supporting assembly 700 includes a plurality of second supporting elements 710, a plurality of first abutting elements 720, a plurality of second abutting elements 730, and a plurality of magnetic shielding elements 740. In the present embodiment, the second supporting assembly 700 is a combination of three spheres abutting against the abutting elements. The second supporting elements 710 are three spheres; therefore, the second supporting elements 710 have a curved surface S710, and the curved surface S710 is not parallel to a direction of the thickness of the first supporting element 610.

The first abutting elements 720 and the second abutting elements 730 are made of metal material and correspond to the second supporting elements 710, and may directly contact, or contact via lubricating oil with the second supporting elements 710. The first abutting elements 720 are embedded in the lower cover 320 of the fixed part 300. The second abutting elements 730 are embedded in the first movable part 100. The first abutting elements 720 and the second abutting elements 730 are movable relative to each other.

The first abutting element 720 has a first abutting surface S720 that faces the second supporting element 710. The second abutting element 730 has a second abutting surface S730 that faces the second supporting element 710. The first abutting surface S720 and the second abutting surface S730 face different directions.

Among them, the first abutting elements 720 embedded in the lower cover 320 are exposed in receiving recesses 327 (see FIG. 4). The second supporting elements 710 are received in the receiving recesses 327 of the lower cover 320 and move relative to the first abutting elements 720 and the second abutting elements 730, thereby allowing the first movable part 100 to smoothly move relative to the fixed part 300.

In the present embodiment, the second supporting elements 710 are disposed only at the first corner 323, the second corner 324, and the third corner 325. That is, the second supporting elements 710 are not disposed on the fourth corner 326. When viewed along the optical axis Op, the diagonal line L1 does not pass through a center of the second supporting element 710 located on the second corner 324.

The magnetic shielding elements 740 may reduce magnetic interference between the first driving assembly 400 and the stabilizing assembly 900 and the sensing assembly 1000. The magnetic shielding elements 740 are made of metal material. The magnetic shielding elements 740 and the second abutting elements 730 have an integrally formed structure. That is, the magnetic shielding elements 740 are at least partially embedded together in the first movable part 100.

When viewed along the first axis O1, the first elastic portion 613 of the first supporting assembly 600 and the second supporting elements 710 at least partially overlap.

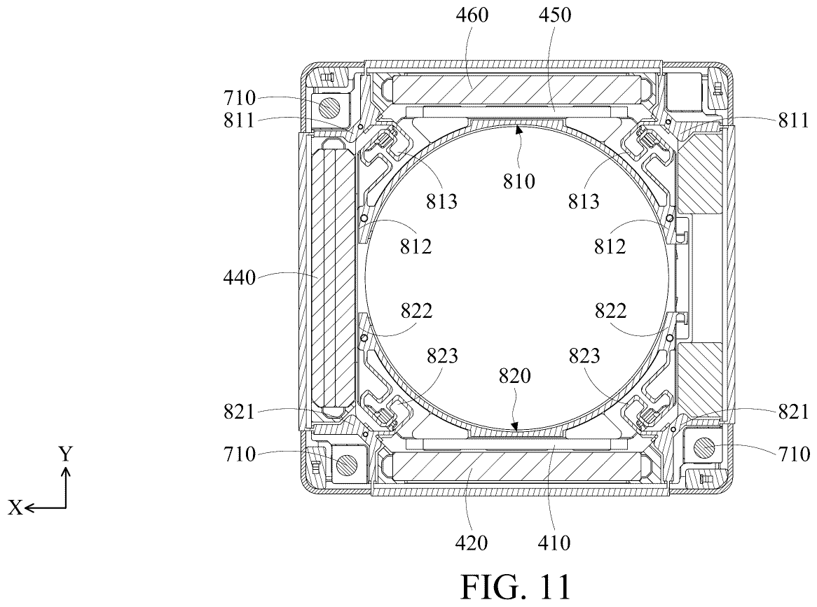

Next, please refer to FIG. 11 together. FIG. 11 is a sectional view of the optical element driving mechanism 1 taken along line A-A of FIG. 1A according to certain aspects of the present disclosure.

The third supporting assembly 800 movably connects the first movable part 100 and the second movable part 200. The third supporting assembly 800 includes a plurality of third supporting elements 810 and 820, and the third supporting elements 810 and 820 have similar plate-shaped structures and detailed structures. The plate-shaped structures are perpendicular to the first axis O1.

The third supporting element 810 includes a first movable part connecting portion 811, a connecting elastic portion 813, and a second movable part connecting portion 812. The first movable part connecting portion 811 is at least partially fixedly connected to the first movable part 100. The second movable part connecting portion 812 is at least partially fixedly connected to the second movable part 200. The connecting elastic portion 813 has flexibility. The first movable part connecting portion 811 is connected to the second movable part connecting portion 812 via the connecting elastic portion 813. The second driving assembly 500 is electrically connected to the third supporting element 810. The third supporting element 810 is electrically connected to the electronic component 220 via the circuit member 210 of the second movable part 200.

The third supporting element 820 includes a first movable part connecting portion 821, a connecting elastic portion 823, and a second movable part connecting portion 822. The first movable part connecting portion 821 is at least partially fixedly connected to the first movable part 100. The second movable part connecting portion 822 is at least partially fixedly connected to the second movable part 200. The connecting elastic portion 823 has flexibility. The first movable part connecting portion 821 is connected to the second movable part connecting portion 822 via the connecting elastic portion 823. The second driving assembly 500 is electrically connected to the third supporting element 820. The third supporting element 820 is electrically connected to the electronic component 220 via the circuit member 210 of the second movable part 200. The third supporting element 820 is connected to the other third supporting element 810 via the electronic component 220.

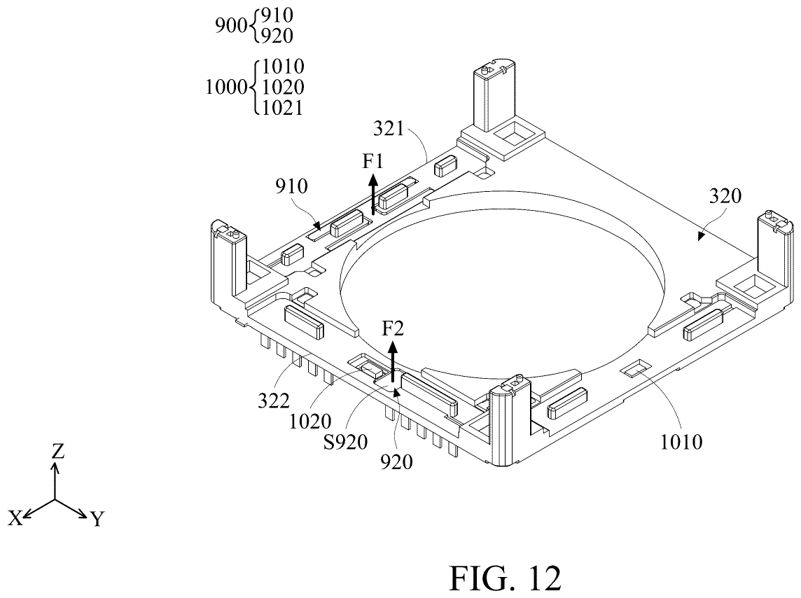

Next, please refer to FIGS. 2 and 12 together. FIG. 12 is a perspective view of the lower cover 320 assembled with the stabilizing assembly 900 and the sensing assembly 1000 of the optical element driving mechanism 1 according to certain aspects of the present disclosure.

The stabilizing assembly 900 includes a first magnetic element 910 and a second magnetic element 920. The first magnetic element 910 is attracted toward the first magnet 420 to generate a first stabilizing force F1 on the first movable part 100. The second magnetic element 920 is attracted toward the second magnet 440 to generate a second stabilizing force F2 on the first movable part 100. The first magnetic element 910 has a first magnetic element surface S910 facing the first movable part 100. The second magnetic element 920 similarly has a second magnetic element surface S920 facing the first movable part 100. In a direction perpendicular to the first magnetic element surface S910 (for example, along the first axis O1 direction or along the Z-axis direction), a gap exists between the first magnetic element surface S910 and the second magnetic element surface S920. That is, the first magnetic element surface S910 and the second magnetic element surface S920 are not at the same position along the direction of the first axis O1.

When viewed along the optical axis Op, the first magnetic element 910 is located on the first side 321 of the lower cover 320, and the second magnetic element 920 is located on the second side 322.

The sensing assembly 1000 includes a first sensing element 1010, a second sensing element 1020, and a reference element 1021 (FIG. 2). The first sensing element 1010 is configured to sense the movement of the first movable part 100. The first sensing element 1010 outputs a first sensing signal.

When viewed in a direction parallel to the first magnetic element surface S910 (for example, when viewed along the Y-axis direction in the figure), the first sensing element 1010 and the first magnetic element 910 at least partially overlap.

The second sensing element 1020 is configured to sense the movement of the second movable part 200. The second sensing element 1020 corresponds to the reference element 1021. The electronic component 220 is electrically connected to the second sensing element 1020. The first supporting element 610 is electrically connected to the second sensing element 1020 via the electronic component connecting portion 616.

When viewed along the optical axis Op, the reference element 1021 and the first magnet 420 at least partially overlap. When viewed along the optical axis Op, a center of the reference element 1021 does not overlap a center of the first magnet 420. When viewed along the optical axis Op, the center of the reference element 1021 is closer to a center of the optical element than the center of the first magnet 420. The magnetic shielding element 740 is at least partially located between the first magnet 420 and the reference element 1021 of the sensing assembly 1000.

In summary, the present invention provides an optical element driving mechanism including multiple movable parts, a fixed part, multiple driving assemblies, and multiple supporting assemblies. Movements of the driving assemblies drive the multiple movable parts to move relative to the fixed part. Accordingly, the position of the optical element may be adjusted to accommodate various imaging requirements and provide more stable optical quality. Meanwhile, through the geometric configuration of the first supporting assembly and the second supporting assembly, the stabilizing forces provided by the magnetic stabilizing assembly, the configuration of the sensing assembly, and the magnetic interference suppression of the magnetic shielding structure, the overall mechanism may still achieve stability of motion, rotational suppression, sensing precision, and structural reliability within a limited space.

Through the integration of the supporting assemblies and the circuit member, the driving and sensing of the second movable part become easier to arrange and connect. the inner and outer structures of the first movable part and the second movable part reduces height stacking, suppressing rotation via outer elastic structures, and reducing component quantity to enhance reliability, the configuration of the present disclosure may also achieve corresponding improvements without increasing unnecessary thickness, and simplify the design of control circuits.

Although one or more embodiments of the present disclosure have been illustrated and described with respect to certain implementations, those skilled in the art, upon reading and understanding this specification and the accompanying drawings, will envision equivalents and modifications. In addition, although specific features of the invention may have been disclosed with respect to only one embodiment among several possible embodiments, such features may, as needed and advantageous for any given or particular application, be combined with one or more other features of other embodiments.

Although various embodiments of the present invention have been described above, it should be understood that these embodiments are presented merely by way of example and not by way of limitation. Various modifications may be made to the embodiments disclosed herein without departing from the spirit or scope of the present invention. Therefore, the breadth and scope of the present invention should not be limited by any of the above-described embodiments. Instead, the scope of the present invention should be defined in accordance with the following claims and their equivalents.

The terminology used herein is for the purpose of describing particular embodiments only and is not intended to limit the present invention. As used herein, the singular forms “a,” “an,” and “the” are intended to include the plural forms as well, unless the context clearly indicates otherwise. Furthermore, the terms “including,” “includes,” “having,” “has,” “with,” or variations thereof, as used in the embodiments and/or the claims, are intended to be interpreted in a manner similar to the term “comprising.”.

What is claimed is:

1. An optical element driving mechanism, comprising:
a first movable part, configured to connect to an optical element;
a fixed part, wherein the first movable part is movable relative to the fixed part; and
a first driving assembly, configured to drive the first movable part to move.

2. The optical element driving mechanism as claimed in claim 1, further comprising:
a first supporting assembly, wherein the first movable part is movable relative to the fixed part via the first supporting assembly; and
a second supporting assembly, wherein the first movable part is movable relative to the fixed part via the second supporting assembly, wherein
a first supporting element of the first supporting assembly has a plate-shaped structure; and
a second supporting element of the second supporting assembly has a curved surface, and the curved surface is not parallel to the direction of the thickness of the first supporting element.

3. The optical element driving mechanism as claimed in claim 2, wherein the first supporting element further comprises:
a fixed part connecting portion, at least partially fixedly connected to the fixed part, having a fixed part connecting surface facing a fixed part surface of the fixed part;
a first movable part connecting portion, at least partially fixedly connected to the first movable part, having a first movable part connecting surface facing the fixed part; and
a first elastic portion having flexibility, wherein the first movable part connecting portion is connected to the fixed part connecting portion via the first elastic portion, wherein
on a first axis, the fixed part connecting surface is located between the fixed part surface and the first movable part connecting surface; and
the first axis is perpendicular to the fixed part connecting surface.

4. The optical element driving mechanism as claimed in claim 3, wherein when viewed along the first axis, the first elastic portion and the second supporting element at least partially overlap.

5. The optical element driving mechanism as claimed in claim 2, wherein the second supporting assembly further comprises:
a first abutting element, having a first abutting surface facing the second supporting element; and
a second abutting element, having a second abutting surface facing the second supporting element, wherein
the first abutting surface and the second abutting surface face different directions; and
the first abutting element and the second abutting element are movable relative to each other.

6. The optical element driving mechanism as claimed in claim 5, wherein:
the first abutting element is made of metal material and corresponds to the second supporting element; and
the second abutting element is made of metal material and corresponds to the second supporting element.

7. The optical element driving mechanism as claimed in claim 5, further comprising a stabilizing assembly, configured to stabilize the first movable part, wherein the stabilizing assembly comprises:
a first magnetic element, configured to apply a first stabilizing force to the first movable part; and
a second magnetic element, configured to apply a second stabilizing force to the first movable part, wherein
the first magnetic element has a first magnetic element surface facing the first movable part;
the second magnetic element has a second magnetic element surface facing the first movable part; and
in a direction perpendicular to the first magnetic element surface, a gap exists between the first magnetic element surface and the second magnetic element surface.

8. The optical element driving mechanism as claimed in claim 7, wherein when viewed along an optical axis, the fixed part has a polygonal structure and comprises:
a first side;
a second side;
a first corner, adjacent to the first side;
a second corner, located between the first side and the second side;
a third corner, adjacent to the second side; and
a fourth corner, wherein
when viewed along the optical axis, a diagonal line passes through the second corner and the fourth corner; and
when viewed along the optical axis, the first magnetic element is located on the first side, and the second magnetic element is located on the second side.

9. The optical element driving mechanism as claimed in claim 8, wherein the second supporting element is disposed on the first corner, the second corner, or the third corner, and the second supporting element is not disposed on the fourth corner.

10. The optical element driving mechanism as claimed in claim 8, wherein the second supporting element is located on the second corner, and when viewed along the optical axis, the diagonal line does not pass through a center of the second supporting element.

11. The optical element driving mechanism as claimed in claim 8, further comprising a sensing assembly, wherein:
a first sensing element of the sensing assembly is configured to sense movement of the first movable part; and
when viewed in a direction parallel to the first magnetic element surface, the first sensing element and the first magnetic element at least partially overlap.

12. The optical element driving mechanism as claimed in claim 11, wherein the first driving assembly comprises:
a first coil;
a first magnet, corresponding to the first coil;
a second coil; and
a second magnet, corresponding to the second coil, wherein
when viewed along the optical axis, the first coil is located on the first side, and the second coil is located on the second side;
a number of turns of the first coil differs from a number of turns of the second coil; and
the number of turns of the second coil is greater than the number of turns of the first coil.

13. The optical element driving mechanism as claimed in claim 12, further comprising:
a second movable part, connecting to the optical element; and
a second driving assembly, configured to drive the second movable part to move, wherein
the second movable part is movable relative to the first movable part.

14. The optical element driving mechanism as claimed in claim 13, wherein the first supporting element further comprises:
a second movable part connecting portion, at least partially fixedly connected to the second movable part, wherein the second movable part connecting portion has a second movable part connecting surface facing a second movable part surface of the second movable part; and
a second elastic portion having flexibility, wherein the second movable part connecting portion is connected to the first movable part connecting portion via the second elastic portion, wherein
along the first axis, the second movable part connecting surface is located between the second movable part surface and the first movable part connecting surface.

15. The optical element driving mechanism as claimed in claim 13, wherein the sensing assembly further comprises:
a second sensing element, configured to sense movement of the second movable part; and
a reference element, wherein the second sensing element corresponds to the reference element, wherein
when viewed along the optical axis, the reference element and the first magnet at least partially overlap;
when viewed along the optical axis, a center of the reference element does not overlap a center of the first magnet; and
when viewed along the optical axis, the center of the reference element is closer to a center of the optical element than the center of the first magnet.

16. The optical element driving mechanism as claimed in claim 15, further comprising a magnetic shielding element made of metal material, wherein the magnetic shielding element is at least partially located between the first magnet and the reference element.

17. The optical element driving mechanism as claimed in claim 16, wherein:
the magnetic shielding element and the second abutting element have an integrally formed structure; and
the magnetic shielding element is at least partially embedded in the first movable part.

18. The optical element driving mechanism as claimed in claim 15, wherein:
the first supporting element is electrically connected to an optical module;
the optical module and the optical element are arranged along an optical axis direction; and
the first supporting element is electrically connected to the second driving assembly or the second sensing element.

19. The optical element driving mechanism as claimed in claim 13, further comprising:
a third supporting assembly, wherein the second movable part is movably connected to the first movable part via the third supporting assembly;
wherein a third supporting element of the third supporting assembly has a plate-shaped structure and is perpendicular to the first axis; and
the second driving assembly is electrically connected to the third supporting element.

20. The optical element driving mechanism as claimed in claim 19, wherein:
the second movable part further comprises a circuit member at least partially embedded in the second movable part;
the second movable part further comprises an electronic component electrically connected to the second sensing element;
the third supporting element is electrically connected to the electronic component via the circuit member;
the electronic component is electrically connected to the first supporting element;
the first supporting assembly further comprises another first supporting element;
the electronic component is electrically connected to the other first supporting element via the circuit member; and
along the first axis, the electronic component is at least partially located between the first supporting element and the circuit member.
